(19) United States
(12) Patent Application Publication
(10) Pub. No.: US 2015/0267827 A1
(43) Pub. Date: Sep. 24, 2015

(54) Rupture Disk Assembly

(71) Applicant: Pentair Flow Services AG, Schaffhausen (CH)

(72) Inventor: Aubert Dee Harris, Beaumont, TX (US)

(21) Appl. No.: 14/667,354

(22) Filed: Mar. 24, 2015

Related U.S. Application Data
(60) Provisional application No. 61/969,431, filed on Mar. 24, 2014.

(51) Int. Cl. F16K 17/16; F16K 1/32

(52) U.S. Cl. CPC F16K 17/16; F16K 1/32

(57) ABSTRACT

Embodiments of the invention provide a relief valve including a main valve having an inlet, an outlet, a piston assembly arranged between the inlet and the outlet and a rupture disk assembly arranged adjacent to and in fluid communication with the inlet. The relief valve further includes an unloader valve having, a bias pressure inlet, a bias pressure outlet, and an unloader valve element moveable between a first unloader position where fluid communication is inhibited between the bias pressure inlet and the bias pressure outlet and a second position where fluid communication is provided between the bias pressure inlet and the bias pressure outlet. The relief valve further includes a pilot valve having a pilot inlet port in fluid communication with the inlet upstream of the rupture disk, a pilot exhaust port in fluid communication with the outlet, and a pilot dome port.

### RELATED APPLICATIONS

This application claims priority under 35 U.S.C. §119 to U.S. Provisional Patent Application No. 61/969,431 filed on Mar. 24, 2014, the entire disclosure of which is incorporated herein by reference.

### BACKGROUND

Pressure relief valves may be used with compressors, engines, hydrocarbon processing facilities, or other systems where pressure needs to be managed. Typically, rupture disks are a sacrificial element used integrally with pressure relief valves. Rupture disks are designed to burst open at a burst pressure. The burst pressure is a characteristic of the rupture disk and may be related to a thickness, material, and/or shape of the rupture disk, etc. Rupture disks typically do not accommodate large fluctuations in pressure above the burst pressure without bursting and requiring replacement. Furthermore, inconsistencies in manufacturing and/or material properties may cause inaccuracies in the burst pressure of the rupture disk.

### BRIEF SUMMARY OF THE INVENTION

A need exists for a rupture disk assembly that will open with greater accuracy and allow for more flexibility with respect to installation and integration with pressure relief valves.

The above shortcomings are overcome by providing a rupture disk assembly that is easily integrated into a plurality of pressure relief valve configurations and that bursts in reaction to actuation of a pilot valve.

Some embodiments of the invention provide a relief valve including a main valve having an inlet, an outlet, a piston assembly arranged between the inlet and the outlet and moveable between a first position where fluid communication is inhibited between the inlet and the outlet and a second position where fluid communication is provided between the inlet and the outlet. The main valve further includes a rupture disk assembly having a rupture disk arranged adjacent to and in fluid communication with the inlet. The rupture disk assembly defines a bias pressure chamber arranged downstream of the rupture disk and upstream of the piston assembly. The relief valve further includes a bias pressure source providing a bias pressure to the bias pressure chamber, an unloader valve configured to selectively provide fluid communication between the bias pressure chamber and the outlet, and a pilot valve configured to selectively provide communication between the unloader valve and the outlet.

Some embodiments of the invention provide a relief valve that includes a housing defining an inlet and an outlet, a valve element arranged between the inlet and the outlet and movable between a closed position where communication is inhibited between the inlet and the outlet and an open position where communication is provided between the inlet and the outlet. The valve element moving from the closed position toward the open position in response to a predetermined opening pressure in the inlet. The relief valve also includes a first rupture disk arranged upstream of the valve element and defining a first burst pressure that is less than the opening pressure, a second rupture disk arranged upstream of the valve element and downstream of the first rupture disk, and defining a second burst pressure that is less than the first burst pressure, a bias pressure chamber defined downstream of the first rupture disk and upstream of the second rupture disk, a bias pressure source providing a bias pressure to the bias pressure chamber, the bias pressure is less than the second burst pressure, an unloader valve configured to selectively provide communication between the bias pressure chamber and the outlet, and a pilot valve configured to selectively provide communication between the unloader valve and the outlet.

### BRIEF DESCRIPTION OF DRAWINGS

FIG. 1 is a cross sectional and schematic view of a relief valve in a first position according to one embodiment of the intention.

FIG. 2 is a cross sectional and schematic view of the relief valve of FIG. 1 in a second position.

FIG. 3 is a cross sectional and schematic view of an unloader valve according to one embodiment of the invention.

FIG. 4 is a cross sectional and schematic view of a relief valve according to another embodiment of the invention.

FIG. 5 is a cross sectional and schematic view of a relief valve according to yet another embodiment of the invention.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

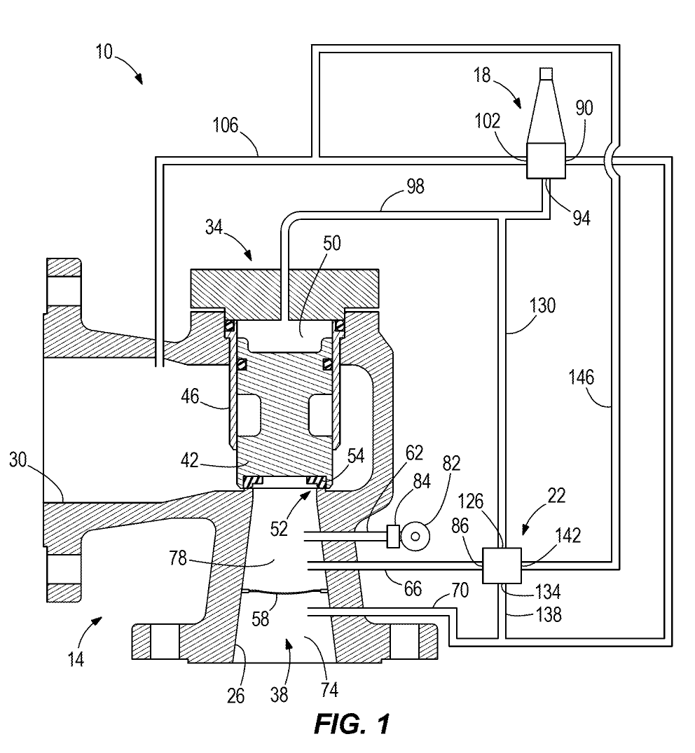

FIG. 1 illustrates a relief valve 10 according to one embodiment of the invention. The relief valve 10 includes a main valve 14, a pilot valve 18, and an unloader valve 22. The main valve includes an inlet 26 for receiving a fluid (e.g., air, water, gas, oils, etc.), an outlet 30 through which the fluid is discharged, a piston assembly 34 disposed between the inlet 26 and the outlet 30, and a rupture disk assembly 38 arranged within the inlet 26. In other embodiments, the relief valve 10 can include various accessory configuration options, such as, emergency dumping, an imminent opening alert, and an actual opening alert, etc.

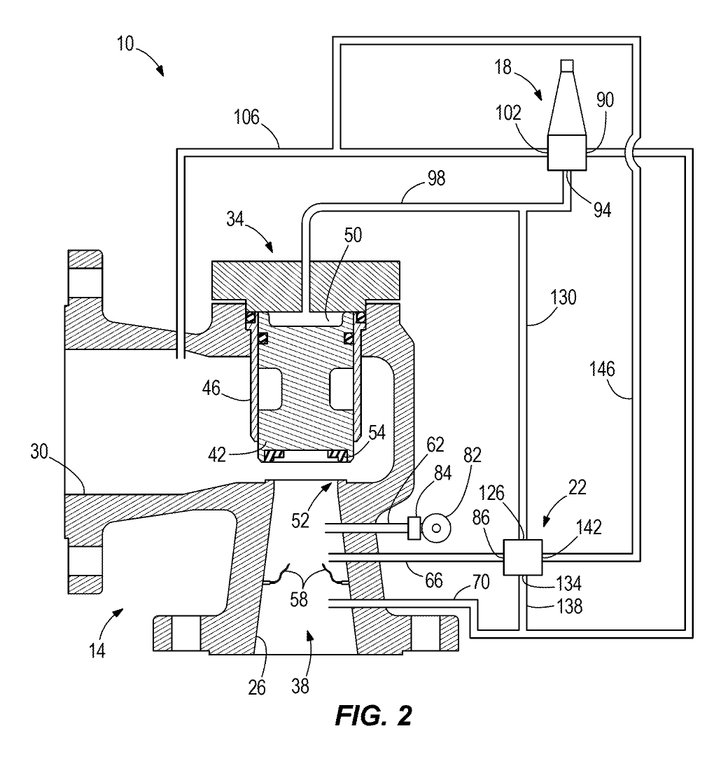

The piston assembly 34 includes a piston 42 sealingly received within a piston sleeve 46 and defining a dome 50 above the piston 42, and a main valve seat 54 configured to engage a sealing feature 52 of the inlet 26. The piston 42 is moveable between a first position (FIG. 1) in which fluid communication is inhibited between the inlet 26 and the outlet 30, and a second position (FIG. 2) in which fluid communication is provided between the inlet 26 and the outlet 30.

As shown in FIG. 1, the rupture disk assembly 38 includes a rupture disk 58 mounted within the inlet 26, a bias pressure port 62, a bias pressure line 66, and a sensing line 70. The rupture disk assembly 38 defines a process chamber 74 arranged between the rupture disk 58 and the fluid, and a bias pressure chamber 78 between the rupture disk 58 and the piston 42. The rupture disk 58 is a sacrificial element designed to break open at a burst pressure, and can be manufactured from metal, graphite, plastic, or any other suitable material. In some embodiments, the rupture disk assembly 38 is arranged within the inlet 26 of the relief valve 10. In other embodiments, the rupture disk assembly 38 can be coupled to the inlet 26 of the relief valve 10 using a disk holder, or another suitable attachment mechanism . In still other embodiments, the rupture disk assembly 38 can include two or more rupture disks.

The bias pressure port 62 is in fluid communication with a bias pressure source 82 that pressurizes the bias pressure chamber 78. The bias pressure source 82 includes a pressure regulator 84 to control and maintain a constant pressure in the bias pressure chamber 78. In one embodiment, the bias pressure source 82 can be a pressurized gas bottle, for example, compressed nitrogen gas, compressed air, or compressed argon. In other embodiments, the bias pressure source 82 can be continuous source of pressure, for example, line pressure from a compressor. In still other embodiments, the bias pressure source 82 can be another suitable controlled source of pressurized fluid. In most embodiments, the bias pressure source 82 is not the process pressure taken from the inlet 26 or other product line pressure.

The bias pressure line 66 provides fluid communication between the bias chamber 78 and a bias pressure inlet 86 of the unloader valve 22. The sensing line 70 provides fluid communication between the process chamber 74 and a pilot inlet port 90 of the pilot valve 18.

The pilot valve 18 includes the pilot inlet port 90, a pilot dome port 94 in fluid communication with the dome 50 of the main valve 14 via a dome pressure line 98, and an pilot exhaust port 102 in fluid communication with the outlet 30 of the main valve 14 via an exhaust line 106. The pilot valve 18 is actuated between a first pilot arrangement when the pressure in the process chamber 74 is less than an actuation pressure of the pilot valve 18 and a second pilot arrangement when the pressure in the process chamber 74 is greater than or equal to the actuation pressure of the pilot valve 18. The first pilot arrangement provides fluid communication between the pilot inlet port 90 and the pilot dome port 94 to pressurize the dome 50. The second pilot arrangement inhibits fluid communication between the pilot inlet port 90 and the pilot dome port 94, and provides fluid communication between the pilot dome port 94 and the pilot exhaust port 102 to vent the pressure in the dome 50 to the outlet 30 of the main valve 14 through the exhaust line 106. In one embodiment, the actuation pressure of the pilot valve 18 can be set to a fixed pressure. In other embodiments, the pilot valve 18 can include an adjustment mechanism for manually or electronically adjusting the actuation pressure.

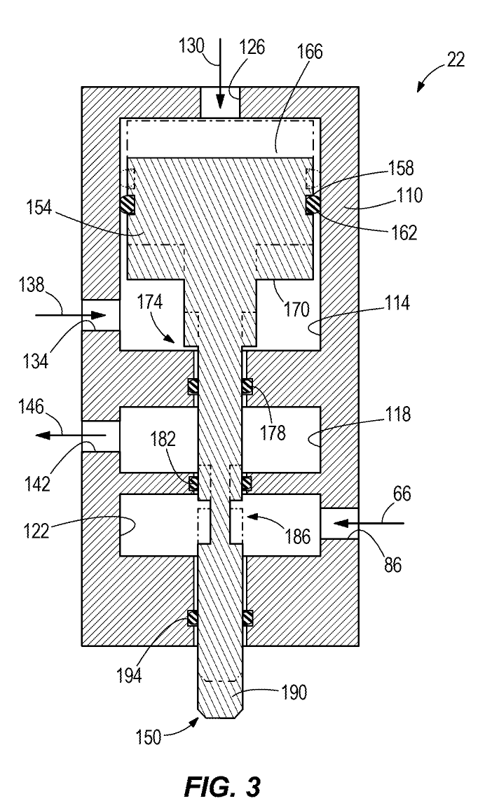

As shown in FIGS. 1 and 3, the unloader valve 22 includes a housing 110 defining a piston chamber 114, an exhaust chamber 118, and an unloader bias pressure chamber 122. The piston chamber 114 includes an unloader dome port 126 in fluid communication with the dome pressure line 98 via an unloader dome pressure line 130, and an unloader sensing port 134 in fluid communication with the sensing line 70 via an unloader sensing line 138. The exhaust chamber 118 includes a bias pressure outlet 142 in fluid communication with the exhaust line 106 via an unloader exhaust line 146. The unloader bias pressure chamber 122 includes the bias pressure inlet 86 in fluid communication with the bias chamber 78 via the bias pressure line 66.

A valve element 150 is positioned within the housing 110 and defines an unloader piston 154 having a groove 158 for holding an unloader piston seal 162, which can be an o-ring. The o-ring 162 is arranged to engage the piston chamber 114 to inhibit fluid communication between the unloader sensing port 134 and the unloader dome port 126. The piston 154 defines a dome surface 166 and a sensing surface 170. A first surface area of the dome surface 166 is larger than a second surface area of the sensing surface 170.

The valve element 150 further defines a movement limit stop 174 that limits the movement of the valve element 150. A movement limit stop seal 178, which can be an o-ring, is positioned between the piston chamber 114 and the exhaust chamber 118 to inhibit fluid communication between the unloader sensing port 134 and the bias pressure outlet 142. An exhaust seal 182, which can be an o-ring, is positioned between the exhaust chamber 118 and the unloader bias pressure chamber 122 to selectively inhibit fluid communication between the bias pressure inlet 86 and the bias pressure outlet 142.

The valve element 150 further defines a cutout 186 and a valve stem 190. The cutout 186 is arranged to selectively provide fluid communication between the bias pressure inlet 86 and the bias pressure outlet 142. The valve stem 190 extends at least partially outside the housing 110 to balance the valve element 150 and provide an actuator for potential pilot valve indicators. A unloader stem seal 194,which can be an o-ring, inhibits fluid flow out of the housing 110 from the unloader bias pressure chamber 122.

The unloader valve 22 is configured to inhibit fluid communication between the bias pressure inlet 86 and the bias pressure outlet 142 via the exhaust seal 182 when the valve element 150 is in a first unloader position (FIG. 3), and to provide fluid communication between the bias pressure inlet 86 and the bias pressure outlet 142 via the cutout 186 when the valve element 150 is in a second unloader position (shown in broken lines in FIG. 3). The valve element 150 is configured to be in the first unloader position when the pressure in the process chamber 74 is less than the actuation pressure of the pilot valve 18, and to move to the second unloader position if the pressure in the process chamber 74 is greater than or equal to the actuation pressure of the pilot valve 18.

FIGS. 1-3 illustrate operation of the relief valve 10. The operation of the relief valve 10 will be described assuming the inlet 26 of the relief valve 10 is coupled to a pressure vessel containing a pressurized fluid (hereinafter the pressure of the pressurized fluid will be referred to as “process pressure”), and the outlet 30 is vented to atmosphere. However, this is one embodiment of the operation of the relief valve 10, and the relief valve 10 can be applied to any system that requires pressure relief. In one embodiment, the actuation pressure of the pilot valve 18 is five hundred pounds-per-square-inch (500 psi), the burst pressure of the rupture disk 58 is four hundred pounds-per-square-inch (400 psi), and the bias pressure source 82 provides one hundred and fifty pounds-per-square-inch (150 psi) to the bias pressure chamber 78. These values can be modified to conform to each specific application of the relief valve 10.

During operation, the process pressure may build in the process chamber 74. The pressure in the process chamber 74 is communicated to the pilot inlet port 90 via the sensing line 70 and to the unloader sensing port 134 via the unloader sensing line 138. From the pilot inlet port 90, the process pressure is communicated to the pilot dome port 94 and to the dome 50 via the dome pressure line 98, and to the unloader dome port 126 via the unloader dome pressure line 130. As a result, the process pressure is communicated to the unloader sensing port 134 and the unloader dome port 126 in the piston chamber 114. As described above, the surface area of the dome surface 166 is larger than the surface area of the sensing surface 170. Force is equal to pressure times area which forces the valve element 150 is into the first unloader position (FIG. 3), because the force acting on the dome surface 166 is larger than the force acting on the sensing surface 170.

As the process pressure builds to 400 psi, for example, the rupture disk 58 will not burst, although the process pressure has reached the burst pressure of the rupture disk 58. This is due to the net pressure acting on the rupture disk 58 being less than the burst pressure. The net pressure acting on the rupture disk 58 is the difference between the process pressure and the pressure provided by the bias pressure source 82. Thus, the net pressure acting on the rupture disk 58 is 400 psi minus 150 psi which equals 250 psi and is less than the burst pressure of the rupture disk 58.

As the process pressure continues to build, the actuation pressure of the pilot valve 18 will eventually be reached. When the process pressure equals the actuation pressure (e.g., 500 psi), the pilot valve 18 will actuate from the first pilot arrangement to the second pilot arrangement. While the pilot valve 18 is in the second pilot arrangement, fluid communication is inhibited between the pilot inlet port 90 and the pilot dome port 94, and fluid communication is provided between the pilot dome port 94 and the pilot exhaust port 102 to vent the pressure in the dome pressure line 98 and the unloader pressure line 130 to the outlet 30 of the main valve 14 through the exhaust line 106. With the pressure in the unloader pressure line 130 vented to the outlet 30, the force acting on the dome surface 166 is no longer larger than the force acting on the sensing surface 170 and the valve element 150 moves into the second unloader position.

While the valve element 150 is in the second unloader position, the unloader valve 22 provides fluid communication between the bias pressure inlet 86 and the bias pressure outlet 142 to vent the bias pressure chamber 78 to the outlet 30 through the bias pressure line 66, the unloader exhaust line 146, and the exhaust line 106. When the pressure has been vented from the bias pressure chamber 78 to the outlet 30, the net pressure acting on the rupture disk 58 will equal 500 psi minus 0 psi (assuming the outlet is at sea level and the measured pressures are gauge pressures) which equals 500 psi. The net pressure (500 psi) acting on the rupture disk 58 is greater than the burst pressure (400 psi), and therefore, the rupture disk 58 bursts. As described above, the pressure in the dome pressure line 98 was vented. Thus, there is no force acting to hold the piston 42 in the first position, and when the rupture disk 58 bursts, the process pressure moves the piston 42 from the first position (FIG. 1) to the second position (FIG. 2). When the piston 42 is in the second position, the process pressure is vented through the main valve 14 from the inlet 26 to the outlet 30 of the main valve 14.

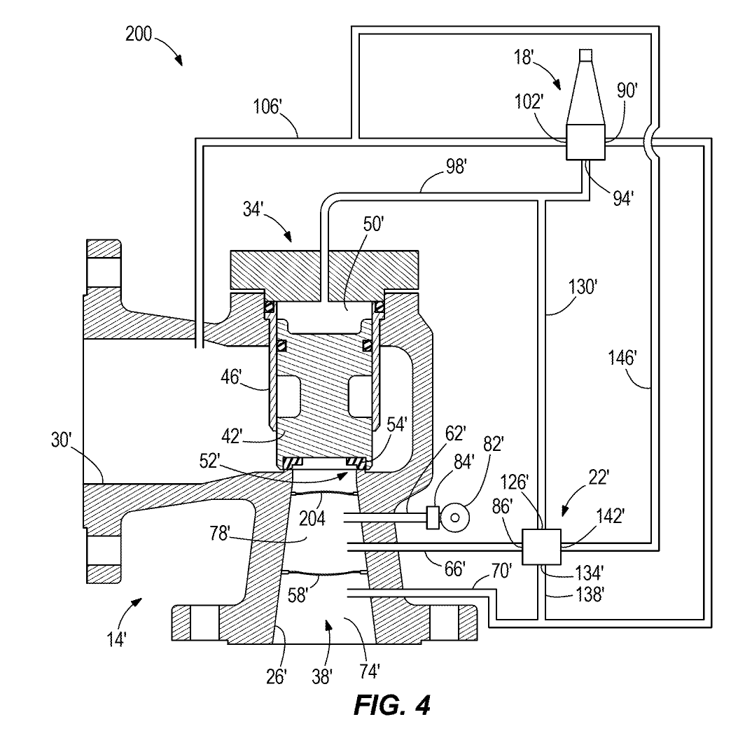

FIG. 4 illustrates a relief valve 200 according to another embodiment of the invention. The relief valve 200 includes similar features to the relief valve 10 with the similar features being identified using a prime next to the element number. The differences between the relief valve 200 and the relief valve 10 will be described below.

The rupture disk assembly 38′ includes a second rupture disk 204. The second rupture disk 204 is positioned downstream from the rupture disk 58′. The bias pressure chamber 78′ is enclosed between the rupture disk 58′ and the second rupture disk 204 to isolate the bias pressure chamber 78′ from the inlet 26′ of the main valve 14′. In other embodiments, the rupture disk assembly 38′ can include three or more rupture disks.

In operation, the burst pressure of the second rupture disk 204 is set slightly above the pressure provided by the bias pressure source 82′. For example, if the bias pressure source 82′ provides 250 psi, the burst pressure of the second rupture disk 204 can be set to 265 psi, or another suitable value. In one embodiment, the burst pressure of the second rupture disk 204 is less than ten percent greater than the pressure provided by the bias pressure source 82′. In another embodiment, the burst pressure of the second rupture disk 204 is about five percent greater than the pressure provided by the bias pressure source 82′. The burst pressure of the second rupture disk 204 should also be significantly below the burst pressure of the first rupture disk 58′ to ensure the process pressure is vented once the rupture disk 58′ bursts. For example, the burst pressure of the second rupture disk 204 can be between about ten percent and fifty percent less than the burst pressure of the rupture disk 58′.

The operation of the relief valve 200 is similar to relief valve 10. As the process pressure reaches the actuation pressure of the pilot valve 18′, the pilot valve 18′ vents the pressure in the dome pressure line 98′ and the unloader pressure line 130′ to the outlet 30′ of the main valve 14′ through the exhaust line 106′. The unloader valve 22′ then vents the bias pressure chamber 78′ and the rupture disk 58′, and the second rupture disk 204 bursts. The piston 42′ then moves from the first position to the second position to vent the process pressure through the main valve 14 from the inlet 26′ to the outlet 30′.

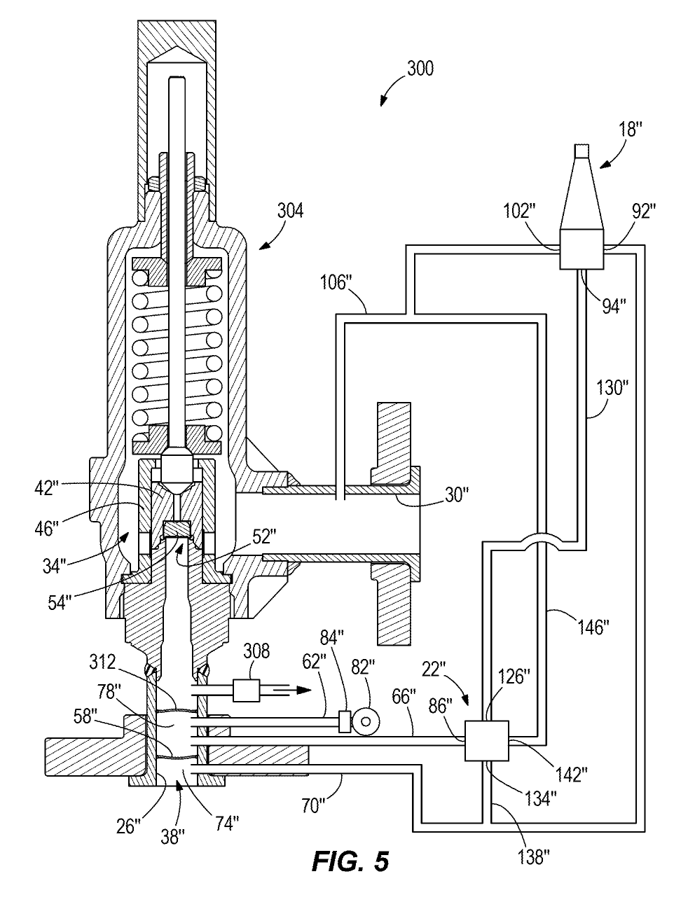

FIG. 5 illustrates a relief valve 300 according to yet another embodiment of the invention. The relief valve 300 includes similar features to the relief valve 10 with the similar features being identified using a double prime next to the element number. The differences between the relief valve 300 and the relief valve 10 will be described below.

The relief valve 300 includes a main valve 304. The main valve 304 is a direct spring operated relief valve (DSORV) with a predetermined opening pressure at which the main valve 304 will allow fluid communication between the inlet 26″ and the outlet 30″. The main valve 304 includes a maximum flow protection valve 308 configured to vent the inlet 26″ if fluid flow through the inlet 26″ reaches a predetermined maximum value. The rupture disk assembly 38″ includes a second rupture disk 312 positioned downstream from the rupture disk 58″. The bias pressure chamber 78″ is enclosed between the rupture disk 58″ and the second rupture disk 312 to isolate the bias pressure chamber 78″ from the inlet 26″ of the main valve 304.

In operation, the predetermined opening pressure of the main valve 14 is greater than the burst pressure of the rupture disk 58″. Additionally, the burst pressure of the rupture disk 58″ is greater than the burst pressure of the second rupture disk 312, and the burst pressure of the second rupture disk 312 is greater than the pressure provided by the bias pressure source 82″. Alternatively these relationships may be represented as follows: the predetermined opening pressure>burst pressure of the rupture disk 58″>burst pressure of the rupture disk 312>pressure provided by bias pressure source 82″. Furthermore, the actuation pressure of the pilot valve 18″ should be set substantially equal to the predetermined opening pressure of the main valve 304.

During operation, as the process pressure reaches the actuation pressure of the pilot valve 18″, the pilot valve 18″ vents the pressure in the dome pressure line 98″ and the unloader pressure line 130″ to the outlet 30″ of the main valve 304 through the exhaust line 106″. The unloader valve 22″ then vents the bias pressure chamber 78″ and the rupture disk 58″, and the second rupture disk 312 bursts. The main valve 304 then allows fluid communication between the inlet 26″ and the outlet 30″, as the process pressure has reached the predetermined opening pressure, to vent the process pressure through the main valve 304.

The rupture disk assemblies 38, 38′, 38″ can be designed to operate in the presence of process pressures very near the actuation pressure of the relief valves 10, 200, 300 (e.g., up to 99.5% of the actuation pressure) without the rupture disks 58, 58′, 58″ bursting, weakening, fatiguing, or leaking This is due to the pressure provided by the bias pressure sources 82, 82′, 82″ reducing the net pressure acting on the rupture disks 58, 58′, 58″. Until the pressure provided by the bias pressure sources 82, 82′, 82″ is removed, the rupture disks 58, 58′, 58″ are not stressed beyond acceptable limits by spikes in temperature or in process pressure above the bursting pressure, but below the actuation pressure.

Due to the rupture disk assemblies 38, 38′, 38″ being designed to operate in the presence of process pressures very near the actuation pressure, the relief valves 10, 200, 300 provide zero emissions of up to 100% of the actuation pressure.

The valve stem 190 can be designed to extend at least partially outside the housing 110. As the unloader valve element 150 moves between the first unloader position and the second unloader position, the valve stem 190 can extend different distances outside the housing 110. Therefore, the valve stem 190 on the unloader valves 22, 22′, 22″ can enable remote sensing of the bursting of the rupture disks 58, 58′, 58″, 204, 312. This prevents a user of the relief valves 10, 200, 300 from having to disassemble the relief valves 10, 200, 300 to determine whether the rupture disks 58, 58′, 58″, 204, 312 have burst. In some embodiments, the valve stem 190 can be coupled to an indication mechanism designed to manually or electronically notify a user of the relief valves 10, 200, 300 that the rupture disks 58, 58′, 58″, 204, 312 have burst.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

1. A relief valve comprising:
a main valve including
an inlet,
an outlet,
a piston assembly arranged between the inlet and the outlet and moveable between a first position where fluid communication is inhibited between the inlet and the outlet, and a second position where fluid communication is provided between the inlet and the outlet, the piston moving toward the second position when a predetermined opening pressure is achieved in the inlet, and
a rupture disk assembly including a rupture disk arranged adjacent to and in fluid communication with the inlet, the rupture disk assembly defining a bias pressure chamber arranged downstream of the rupture disk and upstream of the piston assembly;
a bias pressure source providing a bias pressure to the bias pressure chamber;
an unloader valve configured to selectively provide fluid communication between the bias pressure chamber and the outlet; and
a pilot valve configured to selectively provide communication between the unloader valve and the outlet.

2. The relief valve of claim 1, wherein the unloader valve comprises a bias pressure inlet in fluid communication with the bias pressure chamber, a bias pressure outlet in fluid communication with the outlet, and an unloader valve element moveable between a first unloader position where fluid communication is inhibited between the bias pressure inlet and the bias pressure outlet, and a second unloader position where fluid communication is provided between the bias pressure inlet and the bias pressure outlet.

3. The relief valve of claim 2, wherein the pilot valve comprises a pilot inlet port in fluid communication with the inlet upstream of the rupture disk, a pilot exhaust port in fluid communication with the outlet, and a pilot dome port, the pilot valve actuatable between a first pilot arrangement where fluid communication is inhibited between the pilot inlet port and the pilot exhaust port and fluid communication is provided between the pilot inlet port and the pilot dome port, and a second pilot arrangement where fluid communication is provided between the pilot exhaust port and the pilot dome port and fluid communication is inhibited between the pilot inlet port and the pilot dome port.

4. The relief valve of claim 1, wherein the rupture disk defines a burst pressure that is lower than the opening pressure.

5. The relief valve of claim 1, wherein the rupture disk assembly further comprises a second rupture disk arranged downstream of the rupture disk and adjacent to the inlet, the rupture disk assembly defining the bias pressure chamber between the rupture disk and the second rupture disk.

6. The relief valve of claim 5, wherein the rupture disk defines a first burst pressure and the second rupture disk defines a second burst pressure that is less than the first burst pressure.

7. The relief valve of claim 5, wherein the second rupture disk defines a second burst pressure that is less than about ten percent greater than the bias pressure.

8. The relief valve of claim 5, wherein the second rupture disk defines a second burst pressure that is about five percent greater than the bias pressure.

9. The relief valve of claim 3, wherein the unloader valve further comprises an unloader sensing port in fluid communication with the inlet upstream of the rupture disk and an unloader dome port in fluid communication with the pilot dome port.

10. The relief valve of claim 9, wherein the unloader valve further defines an unloader piston arranged within a unloader piston chamber, the unloader piston defining an unloader dome surface in fluid communication with the unloader dome port and an unloader sensing surface in fluid communication with the unloader sensing port.

11. The relief valve of claim 10, wherein the unloader dome surface defines a surface area larger than a surface area of the unloader sensing surface.

12. The relief valve of claim 11, wherein when the pilot valve is in the first pilot arrangement the unloader valve element moves into the first unloader position, and when the pilot valve is in the second pilot arrangement pressure acting on the unloader dome surface is vented to the outlet to move the unloader valve element into the second unloader position and venting the bias pressure chamber to the outlet.

13. The relief vale of claim 1, wherein the piston assembly further comprises a piston sealingly received within a piston sleeve and defines a piston dome arranged to bias the piston toward the inlet when the dome is pressurized.

14. The relief valve of claim 13, wherein the pilot dome port is in fluid communication with the piston dome.

15. The relief valve of claim 14, wherein when the pilot valve is in the first pilot arrangement the piston dome is in fluid communication with the inlet upstream of the rupture disk, and when the pilot valve is in the second pilot arrangement pressure in the piston dome is vented to the outlet and the piston assembly is moved from the first position toward the second position.

16. The relief valve of claim 1, wherein the piston assembly is biased toward the second position by a spring.

17. The relief valve of claim 1, wherein the bias pressure source further includes a pressure regulator configured to regulate the bias pressure.

18. A relief valve comprising:
a housing defining an inlet and an outlet;
a valve element arranged between the inlet and the outlet and movable between a closed position where communication is inhibited between the inlet and the outlet and an open position where communication is provided between the inlet and the outlet, the valve element moving from the closed position toward the open position in response to a predetermined opening pressure in the inlet;
a first rupture disk arranged upstream of the valve element and defining a first burst pressure that is less than the opening pressure;
a second rupture disk arranged upstream of the valve element and downstream of the first rupture disk, and defining a second burst pressure that is less than the first burst pressure;
a bias pressure chamber defined downstream of the first rupture disk and upstream of the second rupture disk;
a bias pressure source providing a bias pressure to the bias pressure chamber, the bias pressure being less than the second burst pressure;
an unloader valve configured to selectively provide communication between the bias pressure chamber and the outlet; and
a pilot valve configured to selectively provide communication between the unloader valve and the outlet.

19. The relief valve of claim 18, wherein the valve element is a pilot actuated piston.

20. The relief valve of claim 19, wherein the piston defines a piston dome and the pilot valve is configured to selectively provide communication between the inlet and pilot dome.

21. The relief valve of claim 18, wherein the valve element is biased toward the closed position by a spring.

22. The relief valve of claim 18, wherein the second burst pressure is less than about ten percent greater than the bias pressure.
